(19) United States
(12) Patent Application Publication
(10) Pub. No.: US 2026/0065727 A1
(43) Pub. Date: Mar. 5, 2026

(54) AI-BASED SELF-OPTIMIZING DOOR OPENING/CLOSING DEVICE AND METHOD

(71) Applicant: AIMATICS CO.,LTD, Seoul (KR)

(72) Inventors: Taesan EOM, Seongnam-si (KR); Joonyoung KIM, Seongnam-si (KR); Hun LEE, Seoul (KR)

(73) Assignee: AIMATICS CO.,LTD, Seoul (KR)

(21) Appl. No.: 19/314,381

(22) Filed: Aug. 29, 2025

(30) Foreign Application Priority Data
Aug. 29, 2024 (KR) 10-2024-0117011

(51) Int. Cl. G07C 9/00; G06V 10/44; G06V 10/74; G06V 10/764; G06V 20/52

(52) U.S. Cl. CPC G07C 9/00174; G06V 10/44; G06V 10/761; G06V 10/764; G06V 20/52

(57) ABSTRACT

The present disclosure relates to an AI-based self-optimizing door opening/closing device and method. The device includes an image acquisition unit that acquires an image of a door entry area via a camera, an object feature extraction unit that analyzes the image of the door entry area and extracts features of an entry/exit intention object, and a door control element determination unit that inputs the features of the entry/exit intention object into an AI-based door control model to optimize a location of the door entry area and determine at least one door control element.

### CROSS-REFERENCE TO RELATED APPLICATION

This application claims the benefit of and priority to Korean Patent Application No. 10-2024-0117011, filed on Aug. 29, 2024, the entire disclosure(s) of which is hereby incorporated herein by reference in its entirety.

### TECHNICAL FIELD

The present disclosure relates to an AI-based self-optimizing door opening/closing device technology, and more specifically, to an AI-based self-optimizing door opening/closing device and method that can analyze a door entry/exit video and control the door to automatically open/close according to the entry/exit intention of an object in the video.

### BACKGROUND

An automatic door is a door that opens and closes automatically by sensors or other control devices. The automatic door is generally used in public places or commercial buildings to help users enter and exit conveniently without having to push or pull the door.

The automatic door may include a sensor, an opening and closing mechanism (for example, motor and gear system), a control device, and a safety device. The sensor attached to the door can detect a person approaching the door or specific movements, and may include infrared, ultrasonic, and radar sensors. In the motor and gear system, when the sensor sends an operation signal, the motor is operated to open and close the door, and the door can be smoothly moved through a gear or belt system. The control device, at the center of the automatic door system, controls all operations, processes signals from the sensors, and regulates the speed and timing of the door's opening and closing. The safety device is commonly installed in automatic doors to prevent people or objects from being trapped when the door opens or closes. For example, the safety device is often designed to immediately reopen the door when an obstruction is detected during the closing process.

Korean Patent No. 10-0753015 (Aug. 22, 2007) discloses a directional sensing automatic door system and opening/closing method for reducing power loss, and the door system includes a frame having an opening formed therein, an opening/closing door that slides left/right or up/down to open/close the opening of the frame, a driving unit that drives the opening/closing door, a camera that detects movement on the upper outer side of the frame, and a control unit that analyzes the image obtained by the camera, determines the movement of a body toward the opening/closing door, and drives the driving unit. According to the directional sensing automatic door system and opening/closing method of the Patent, it is possible to recognize the movement of a person toward the automatic door, prevent malfunction of the automatic door, and prevent unnecessary power consumption. Moreover, it is possible to stably open/close the automatic door, and prevent accidents, that may occur when the automatic door is opened/closed, in advance.

In addition, according to the Patent, the door can be opened and closed manually or automatically according to the user's convenience, attempts to open the automatic door with physical force from the outside can be prevented, and the alarm device can notify of an emergency, thereby further enhancing the security function.

### SUMMARY

One embodiment of the present disclosure provides an AI-based self-optimizing door opening/closing device and method capable of extracting features of an entry/exit intention object by analyzing a door entry/exit area image.

One embodiment of the present disclosure provides an AI-based self-optimizing door opening/closing device and method capable of detecting the appropriateness of an entry/exit intention object and determining whether to open/close a door.

One embodiment of the present disclosure provides an AI-based self-optimizing door opening/closing device and method capable of controlling whether to open/close a door, an opening/closing width, an opening/closing speed, and an opening/closing time through an AI-based door control model.

According to embodiments, there is provided an AI-based self-optimizing door opening/closing device including: an image acquisition unit that acquires a door entry area video via a camera; an object feature extraction unit that analyzes the door entry area video and extracts features of an entry/exit intention object; and a door control element determination unit that inputs the features of the entry/exit intention object into an AI-based door control model to optimize a location of the door entry area and determine at least one door control element.

The object feature extraction unit may extract the features of the entry/exit intention object from the door entry/exit area video through a backbone neural network.

The door control element determination unit may determine at least one of whether to open or close, an opening/closing width, an opening/closing speed, and an opening/closing time as the at least one door control element through the AI-based door control model and perform door opening/closing.

A door control influence factor determination unit may input the features of the entry/exit intention object into an object localizer to determine at least one door control influence factor.

The door control influence factor determination unit may input the features of the entry/exit intention object into a location head to generate a location map, and determine an object validity factor for determining whether to open/close, an object area factor for determining the opening/closing width, an object speed factor for determining the opening/closing speed, and an object distance factor for determining the opening/closing time as the door control influence factors through the location map.

The door control influence factor determination unit may input the features of the entry/exit intention object into a class head to generate a class map, and update the location map and the class map to maximize a GT similarity between the location map and the class map.

A door control feedback unit may calculate attention for a location map and class map in the object localizer and feedback the calculated attention to the door control model.

According to embodiments, there is provided an AI-based self-optimizing door opening/closing method performed by an AI-based self-optimizing door opening/closing device, including: acquiring a door entry area video via a camera; analyzing the door entry area video and extracting features of an entry/exit intention object; and inputting the features of the entry/exit intention object into an AI-based door control model to optimize a location of the door entry area and determine at least one door control element.

### Advantageous Effects

The disclosed technology may have the following effects. However, this does not mean that a particular embodiment should include all or only the following effects, and therefore the scope of the disclosed technology should not be construed as being limited thereby.

According to the AI-based self-optimizing door opening and closing device and method according to one embodiment of the present disclosure, it is possible to extract the features of the entry/exit intention object by analyzing the door entry/exit area image.

According to the AI-based self-optimizing door opening and closing device and method according to one embodiment of the present disclosure, it is possible to detect the appropriateness of the entry/exit intention object and determine whether to open or close the door.

According to the AI-based self-optimizing door opening and closing device and method according to one embodiment of the present disclosure, it is possible to control whether to open or close the door, the opening and closing width, the opening and closing speed, and the opening and closing time through the AI-based door control model.

### BRIEF DESCRIPTION OF THE DRAWINGS

FIG. 1 is a diagram illustrating an AI-based self-optimizing door opening/closing system according to the present disclosure.

FIG. 2 is a diagram illustrating the system configuration of the AI-based self-optimizing door opening/closing system of FIG. 1.

FIG. 3 is a diagram illustrating the functional configuration of the AI-based self-optimizing door opening/closing system of FIG. 1.

FIG. 4 is a flowchart illustrating one embodiment of the AI-based self-optimizing door opening/closing system according to the present disclosure.

FIG. 5 and FIG. 6 are diagrams illustrating a conventional door opening/closing control system.

FIG. 7 to FIG. 10 are diagrams illustrating one embodiment of the AI-based self-optimizing door opening/closing system according to the present disclosure.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between”or “adjacent to”and “directly adjacent to”should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

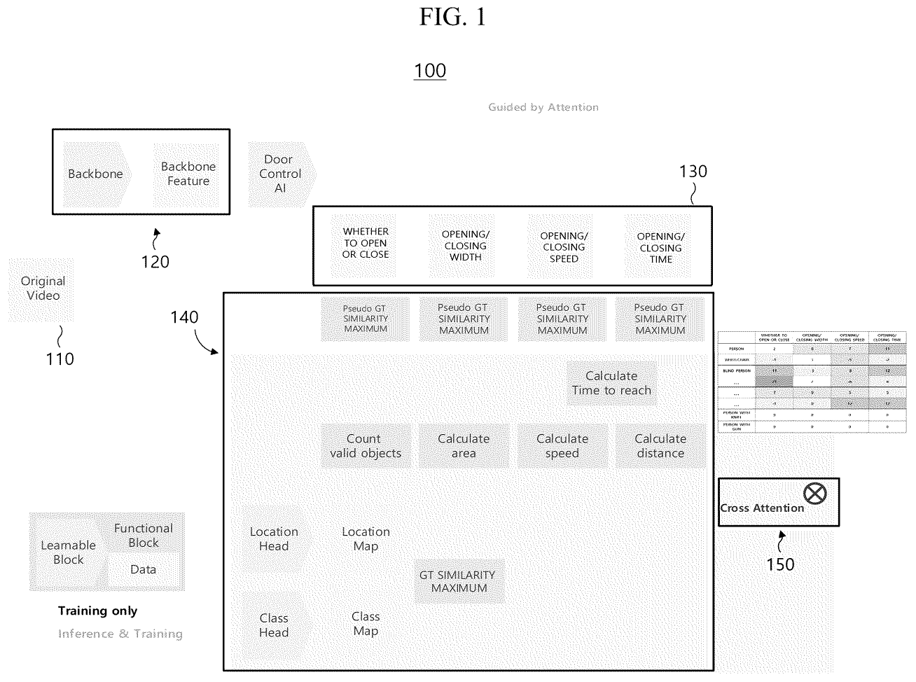

FIG. 1 is a diagram illustrating an AI-based self-optimizing door opening/closing system according to the present disclosure.

Referring to FIG. 1, an AI-based self-optimizing door opening/closing system 100 may include an image acquisition unit 110, an object feature extraction unit 120, a door control element determination unit 130, a door control influence element determination unit 140, and a door control feedback unit 150. Here, for convenience of explanation, the image acquisition unit 110, the object feature extraction unit 120, the door control element determination unit 130, the door control influence element determination unit 140, and the door control feedback unit 150 are described as independent devices, but the present disclosure is not limited thereto. That is, it goes without saying that at least two different devices can be integrated and implemented as one device according to various embodiments for door opening/closing control.

The image acquisition unit 110 may be installed in a door and perform image capturing to collect images of objects approaching the door. Here, the image acquisition unit 110 may be implemented as a Charge-Coupled Device (CCD) camera module. For example, the camera module may correspond to a Charge-Coupled Device (CCD) camera module, a Complementary Metal-Oxide-Semiconductor (CMOS) camera module, an Infrared (IR) camera module, a Time-of-Flight (ToF) camera module, a thermal imaging camera module, a pinhole camera module, a 360-degree camera module, or a hybrid camera module combining two or more sensors, which are installed in the door and capture the entry area.

In one embodiment, the image acquisition unit 110 may collect images and image information about an object approaching the door by taking images of the object and store them in a database. More specifically, the image acquisition unit 110 may generate an image including features of various entry/exit intention objects, including the location, size, and type of the object, by taking images or videos. Here, the features of the entry/exit intention object may correspond to information necessary for detecting the object approaching the door, and may correspond to, for example, the location, size, and type of a specific object approaching the door.

In addition, the image acquisition unit 110 may be implemented as one device that constitutes the AI-based self-optimizing door opening/closing system 100 according to the present disclosure, and the AI-based self-optimizing door opening/closing system 100 may be implemented in various forms depending on the shape of the door and the structure of the building.

The image acquisition unit 110 may be connected to the AI-based self-optimizing door opening/closing system 100 through a network, and a plurality of image acquisition units 110 may be simultaneously connected to the AI-based self-optimizing door opening/closing system 100. The image acquisition unit 110 may be controlled from a user terminal through a dedicated application (APP) for linking with the AI-based self-optimizing door opening/closing system 100. Here, the user terminal may correspond to an administrator terminal that manages the AI-based self-optimizing door opening/closing system 100. In addition, the user terminal may be implemented as a smartphone, laptop, or computer that can be connected to and operate the AI-based self-optimizing door opening/closing system 100, but is not necessarily limited thereto, and may also be implemented as various devices including tablet PCs.

The object feature extraction unit 120 may be implemented as a server corresponding to a computer or program that receives and stores images and video data collected from the image acquisition unit 110 and generates and stores information for detecting an entry/exit intention object approaching the door through data analysis. Here, the object feature extraction unit 120 may have a hierarchical structure to extract features of the entry/exit intention object from the images and video received from the image acquisition unit 110, and may be implemented as, for example, a convolutional neural network (CNN) having at least two layers. In one embodiment, the object feature extraction unit 120 may be implemented to include a backbone and a backbone feature, thereby detecting the entry/exit intention object and performing image segmentation. Here, the backbone may correspond to an artificial intelligence neural network that identifies features of the entry/exit intention object, including the location, size, and type, or the like for a specific entry/exit intention object, and the backbone feature may correspond to an artificial intelligence neural network that performs the role of classifying the features of each entry/exit intention object and distinguishing them by the same attributes. For example, the object feature extraction unit 120 may classify the features of each entry/exit intention object into an object movement direction, object movement speed, and object risk level, or the like based on the backbone feature, and store them in a database.

In addition, the object feature extraction unit 120 may generate a feature map for the object by performing object detection and image segmentation based on the features of the extracted entry/exit intention object. Here, the object detection may correspond to identifying a specific object from an image or video and generating the features of the entry/exit intention object regarding the location, size, and type of the object, and the image segmentation may correspond to dividing the image or video and identifying the object belonging to each pixel.

In one embodiment, the object feature extraction unit 120 may generate learning data for the door control element determination unit 130 based on images and videos captured by the image acquisition unit 110. That is, the object feature extraction unit 120 may extract the features of the entry/exit intention object based on the backbone and backbone features and provide the features of the entry/exit intention object as learning data for the door control element determination unit 130, thereby training the door control element determination unit 130 to perform location optimization for the door entry area and door opening/closing control according to the location, size, and type of an object approaching the door.

The object feature extraction unit 120 may perform additional learning on the door control element determination unit 130 using the learning data, and may also distribute the updated door control element determination unit 130 to each image acquisition unit 110. To this end, the object feature extraction unit 120 may be connected to the image acquisition unit 110 via a wired network or a wireless network such as Bluetooth, WiFi, LTE, or the like, and may transmit and receive data with the image acquisition unit 110 via the network.

The door control element determination unit 130 may be implemented as a computer or server that performs the AI-based self-optimizing door opening/closing method according to the present disclosure. Furthermore, the door control element determination unit 130 may be connected to the image acquisition unit 110 and the user terminal via a wired network or a wireless network such as Bluetooth, WiFi, or LTE, and may transmit and receive data with the image acquisition unit 110 and the user terminal via the network.

The door control element decision unit 130 may be implemented to operate in connection with an independent external system (not illustrated in FIG. 1). For example, the door control element decision unit 130 may operate in conjunction with a platform system or security company that provides door opening/closing control services.

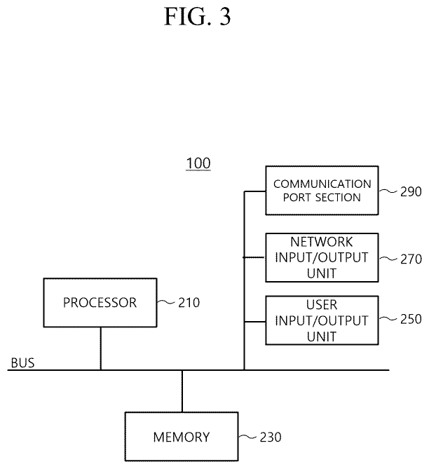

In one embodiment, the door control element determination unit 130 may receive the features of entry/exit intention object from the object feature extraction unit 120 and train to control door opening/closing control operations according to each object. Here, the door control element determination unit 130 may optimize the location of the door entry/exit area and control whether to open/close the door, the opening/closing width, the opening/closing speed, and the opening/closing time according to the location, size, and type of the object. In other words, the door control element determination unit 130 may train which area is most effective to designate as the door entry/exit area, and perform door opening/closing control and door attribute control. Hereinafter, a specific door opening/closing control operation will be described in detail with reference to FIG. 3.

The door control influence factor determination unit 140 may be implemented by further including a location head that performs a function of detecting the object location and a class head that performs a function of determining an object type. Here, the location head may correspond to predicting the location of the object identified in the image or video. In addition, the class head may correspond to predicting the type of object, and for example, may classify a specific object into classes such as a person, an animal, and an object. The class head is not necessarily limited thereto, and may classify a specific object according to object characteristics such as a moving object and a stationary object. In one embodiment, the door control influence factor determination unit 140 may predict the coordinates of a specific object from the image or video based on the location head, and express the location of the object as a bounding box. The bounding box may correspond to indicating an area that the object occupies in the image or video through the center coordinates, width, and height of the specific object.

In one embodiment, the door control influence factor determination unit 140 may be implemented by further including a position prediction module, a position determination unit, a coordinate estimator, an area detection module, and a location analyzer. That is, the door control influence factor determination unit 140 may predict the position of an object identified in an image or video based on the location head further including the position prediction module, the position determination unit, the coordinate estimator, the area detection module, and the location analyzer, and may generate the bounding box at the location of the object. Here, the position prediction module may correspond to predicting an area in which an object is likely to be located in the image or video and generating at least one candidate position. In addition, the position determination unit may correspond to finally determining a position at which an actual object is most likely to exist among the candidate positions provided by the position prediction module.

Additionally, the coordinate estimator may correspond to calculating bounding box coordinates of objects identified in images and videos, for example, generating bounding boxes for objects based on x_min, y_min, x_max, y_max, and center coordinates. The area detection module may detect potential regions containing specific objects in images and videos, thereby detecting areas where objects are likely to be present. The location analyzer may be a module that performs further analysis on the final predicted object location, verifies the accuracy of the predicted location, and adjusts the object location if necessary.

The door control feedback unit 150 may assign weights to the features of the entry/exit intention object through an attention mechanism. Here, the door control feedback unit 150 may train the door control element determination unit 130 to perform door opening/closing control based on features of a specific entry/exit intention object by assigning weights to features of at least one entry/exit intention object. For example, the door control feedback unit 150 may perform door opening/closing control according to object type by assigning weights to object types based on the attention mechanism. In one embodiment, the door control feedback unit 150 may assign the weight to the features of at least one entry/exit intention object based on the attention mechanism and provide the features of the entry/exit intention object to which the weight has been assigned as learning data to the door control element determination unit 130.

Meanwhile, each of the image acquisition unit 110, object feature extraction unit 120, door control element determination unit 130, door control influence element determination unit 140, and door control feedback unit 150 may include a plurality of modules implemented independently to perform related operations, and may be implemented to include a control module that manages control and data flow for the plurality of modules.

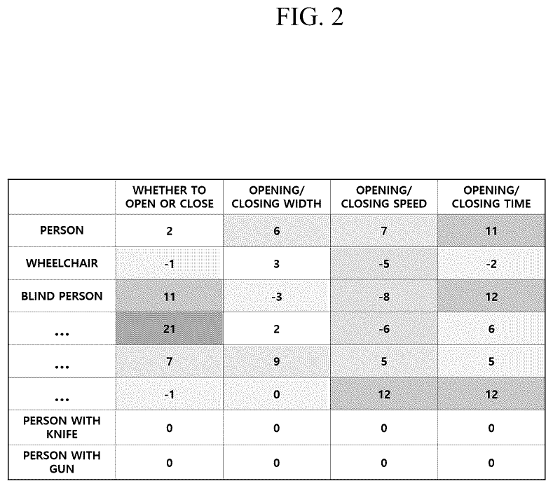

FIG. 2 is a diagram illustrating the system configuration of the AI-based self-optimizing door opening/closing system of FIG. 1.

Referring to FIG. 2, the AI-based self-optimizing door opening/closing system 100 may include a processor 210, a memory 230, a user input/output unit 250, a network input/output unit 270, and a communication port section 290.

The processor 210 may execute an AI-based self-optimizing door opening/closing procedure according to one embodiment of the present disclosure, manage a memory 230 that is read or written in this process, and schedule a synchronization time between a volatile memory and a non-volatile memory in the memory 230. The processor 210 may control the overall operation of the AI-based self-optimizing door opening/closing system 100, and may be electrically connected to the memory 230, the user input/output unit 250, and the network input/output unit 270 to control the data flow therebetween. The processor 210 may be implemented as a Central Processing Unit (CPU) or a Graphics Processing Unit (GPU) of the AI-based self-optimizing door opening/closing system 100.

The memory 230 may include an auxiliary memory device implemented as a non-volatile memory such as a Solid-State Disk (SSD) or a Hard Disk Drive (HDD) and used to store all data required for the AI-based self-optimizing door opening/closing system 100, and may include a main memory device implemented as a volatile memory such as a Random Access Memory (RAM). In addition, the memory 230 may store a set of commands that execute the AI-based self-optimizing door opening/closing method according to the present disclosure by being executed by the electrically connected processor 210.

The user input/output unit 250 includes an environment for receiving user input and an environment for outputting specific information to the user, and may include, for example, an input device including an adapter such as a touchpad, a touch screen, a visual keyboard, or a pointing device, and an output device including an adapter such as a monitor or a touch screen. In one embodiment, the user input/output unit 250 may correspond to a computing device connected via remote access, and in such a case, the domestic and foreign financial product support service platform device 130 may be implemented as an independent server.

The network input/output unit 270 provides a communication environment for connecting to a user terminal via a network, and may include, for example, an adapter for communication such as a Local Area Network (LAN), a Metropolitan Area Network (MAN), a Wide Area Network (WAN), and a Value-Added Network (VAN). In addition, the network input/output unit 270 may be implemented to provide a short-range communication function such as WiFi or Bluetooth, or a wireless communication function of 4G or higher for wireless transmission of data.

The communication port section 290 may be implemented as a port mapping table that performs data routing during the process of transmitting and receiving data over a network. Here, the communication port section 290 may distinguish communication sessions between the image acquisition unit 110 and the server by assigning a unique source port to each image acquisition unit 110, thereby preventing data collisions during the data transmission and reception process.

FIG. 3 is a diagram illustrating the functional configuration of the AI-based self-optimizing door opening/closing system of FIG. 1.

Referring to FIG. 3, the AI-based self-optimizing door opening/closing system 100 may perform the AI-based self-optimizing door opening/closing method according to the present disclosure. To this end, the AI-based self-optimizing door opening/closing system 100 may include the image acquisition unit 110, the object feature extraction unit 120, the door control element determination unit 130, the door control influence element determination unit 140, the door control feedback unit 150, and a control unit 160.

In this case, the embodiments of the present disclosure do not necessarily include all of the above-described components simultaneously. Depending on the embodiment, some of the above-described components may be omitted, or some or all of the above-described components may be selectively included. The operation of each component will be described in detail below.

The image acquisition unit 110 may acquire a door entry area video through a camera. Here, the door entry area video may correspond to an image and video of the object passing through the door, and is not necessarily limited thereto, and may further include images and videos of an object passing through or approaching the area around the door. The image acquisition unit 110 may generate the door entry/exit video by performing image capture of the object approaching the door through a camera. Here, the image acquisition unit 110 may store the door entry area video acquired from the camera in a database in the chronological order.

The object feature extraction unit 120 can analyze the door entry area video to extract the features of the entry/exit intention object. Here, the entry/exit intention object may correspond to an entry/exit intention object derived from a movement path and behavior pattern for a specific object. The object feature extraction unit 120 may identify the object in the door entry/exit video by analyzing the door entry/exit video based on the object feature extraction unit 120. Thereafter, the object feature extraction unit 120 may determine the entry/exit intention of the object by inputting the features of the entry/exit intention object including the movement path and behavior pattern of the object to the door control element determination unit 130. For example, the object feature extraction unit 120 may analyze the features of the entry/exit intention object including the object's movement speed, movement direction, hand movement, and gaze direction through the door control element determination unit 130, thereby performing location optimization for the door entry area and door opening/closing control according to the entry/exit intention.

In one embodiment, the object feature extraction unit 120 may extract the features of the entry/exit intention object from the door entry area video through the object feature extraction unit 120. Here, the object feature extraction unit 120 can input the door entry area video into a backbone neural network to extract the features of the entry/exit intention object, including the object's moving speed, moving direction, object's hand movement, and gaze direction. In addition, the object feature extraction unit 120 may predict the entry/exit intention by analyzing the behavioral pattern of the entry/exit intention object and comparing the behavioral pattern with past entry area images.

The door control element determination unit 130 can input the features of the entry/exit intention object into an AI-based door control model to determine the location optimization for the door entry area and at least one door control element. Here, the door control element may correspond to whether to open/close, the opening/closing width, the opening/closing speed, and the opening/closing time in the process of performing door opening/closing control. The door control element determination unit 130 can perform the door opening/closing operation based on the door control element according to the features of the entry/exit intention object. For example, the door control element determination unit 130 may control the door opening/closing area according to the size of the entry/exit intention object. In addition, the door control element determination unit 130 may set the door opening/closing control to be performed only when the entry/exit intention object is a person, depending on the type of the entry/exit intention object. The door control element determination unit 130 is not necessarily limited thereto, and may control the door opening/closing control speed according to the location of the entry/exit intention object.

In one embodiment, the door control element determination unit 130 may determine at least one of whether to open/close, the opening/closing width, the opening/closing speed, and the opening/closing time as at least one door control element through the AI-based door control model to perform the door opening/closing. For example, the door control element determination unit 350 may perform the door opening/closing operation according to the type of the entry/exit intention object by determining whether to open/close as the door control element. Here, the door control element determination unit 350 may restrict the door opening/closing operation when the entry/exit intention object corresponds to an animal or an object, but is not necessarily limited thereto.

In one embodiment, the door control element determination unit 130 may determine a risk level of the entry/exit intention object when the entry/exit intention object corresponds to a person. Here, the door control element determination unit 130 may analyze the bounding box of the entry/exit intention object and determine the risk level of the entry/exit intention object based on whether the entry/exit intention object contains a knife, a blunt object, or a firearm. That is, the door control element determination unit 130 may restrict the door opening and closing operation when the entry and exit video includes a weapon during the process of analyzing the image and video of the entry/exit intention object.

In one embodiment, the door control element determination unit 130 may perform the door opening/closing operation based on the size and movement speed of the entry/exit intention object by determining at least one of the opening/closing width, the opening/closing speed, and the opening/closing time as the door control element. For example, the door control element determination unit 130 may perform the door opening/closing operation based on the bounding box of the entry/exit intention object and the speed of approaching the door, thereby performing the door opening/closing operation based on the entry/exit intention object's approach to the door.

The door control influence factor determination unit 140 may inputs the features of the entry/exit intention object into the object localizer to determine at least one door control influence factor. Here, the door control influence factor may correspond to a response of the door according to the entry/exit intention object, and may correspond to a response of the door according to, for example, the location, speed, and size of the entry/exit intention object and identity or access authority of the entry/exit intention object. The door control influence factor determination unit 140 may determine a location head and a class head of the entry/exit intention object based on the object localizer. That is, the door control influence factor determination unit 140 may determine the door control influence factor according to the location and type of the entry/exit intention object.

In one embodiment, the door control influence factor determination unit 140 may input the features of the entry/exit intention object into the location head to generate the location map, and may determine, through the location map, an object validity factor for determining whether to open/close, an object area factor for determining the opening/closing width, an object speed factor for determining the opening/closing speed, and an object distance factor for determining the opening/closing time as the door control influence factor. Here, the location map may correspond to a map expressing the location information of the entry/exit intention object, and may correspond to, for example, object location coordinates in the door entry area. The door control influence factor determination unit 140 may determine the object validity factor of the entry/exit intention object based on the features of the entry/exit intention object. Here, the object validity factor may correspond to an element for determining whether the entry/exit intention object is actually likely to pass through the door, but is not necessarily limited thereto, and may correspond to an element for determining whether the entry/exit intention object is capable of entering/exiting. That is, the door control influence factor determination unit 140 may determine the object validity factor of the entry/exit intention object and perform the door opening/closing operation according to the object validity factor.

In addition, the door control influence element determination unit 140 can determine the object area factor and the area of the opening/closing width according to the features of the entry/exit intention object. In addition, the door control element determination unit 130 may determine the door opening/closing speed according to the speed of the entry/exit intention object, and control the door opening/closing time according to the distance between the door and the entry/exit intention object, thereby optimizing the door opening/closing operation according to the features of the entry/exit intention object.

In one embodiment, the door control influence factor determination unit 140 may input the features of the entry/exit intention object into the class header to generate the class map and update the location map and the class map to maximize a GT similarity between the location map and the class map. Here, the GT similarity may correspond to a ground truth in the data, for example, an actual location of the entry/exit intention object in an entry area image and an actual type of the entry/exit intention object. The door control influence factor determination unit 140 may optimize the accuracy of the AI-based door control model by minimizing the difference between the predicted result in the entry/exit intention object detection and classification and the ground through (GT). Here, the door control influence factor determination unit 350 may calculate an error between the GT and the prediction based on a loss function and update the location map and the class map in a direction to minimize the error.

The door control feedback unit 150 may calculate the attention for the location map and class map in the object localizer and feedback the calculated attention to the AI-based door control model. Here, the door control feedback unit 150 may assign the weight to the features of the entry/exit intention object through the attention mechanism. For example, the door control feedback unit 150 may assign priority to whether the entry/exit intention object can enter or exit by assigning the weight to the object validity factor and perform the door opening/closing operations according to the priority. The door control feedback unit 150 is not necessarily limited thereto, and may assign priority by assigning the weight to at least one of the object area factor, the object speed factor, and the object distance factor, and perform the door opening/closing control according to the priority.

The control unit 160 may control the overall operation of the AI-based self-optimizing door opening/closing system 100, and manage the control flow or data flow between the image acquisition unit 110, the object feature extraction unit 120, the door control element determination unit 130, the door control influence element determination unit 140, and the door control feedback unit 150.

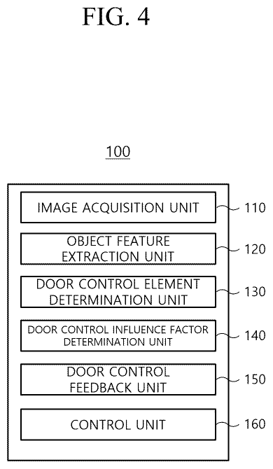

FIG. 4 is a flowchart illustrating one embodiment of the AI-based self-optimizing door opening/closing system according to the present disclosure.

Referring to FIG. 4, the AI-based self-optimizing door opening/closing system 100 may acquire the door entry area video based on the camera through the image acquisition unit 110 (Step S410). The AI-based self-optimizing door opening/closing system 100 may analyze the door entry area video through the object feature extraction unit 120 to extract the features of the entry/exit intention object (Step S430). In addition, the AI-based self-optimizing door opening/closing system 100 may input the features of the entry/exit intention object into the AI-based door control model through the door control element determination unit 130 to determine at least one door control element (Step S450).

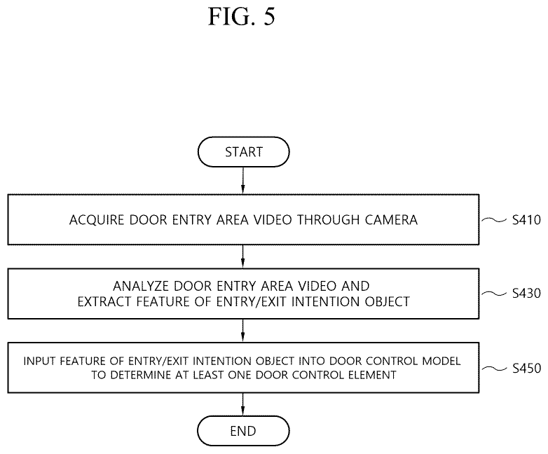

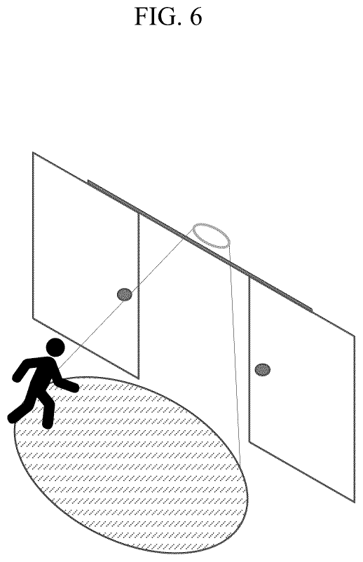

FIGS. 5 and 6 are diagrams illustrating a conventional door opening/closing control system.

Referring to FIG. 5, the conventional door opening/closing control system may identify an object and perform a door opening/closing operation based on a sensor attached around a door. Here, the conventional door opening/closing control system performs the door opening/closing operation based on the object recognition of the sensor even when an object without the intention of entering approaches the door, which causes an unnecessary waste of power consumed during the door opening/closing control process. In addition, referring to FIG. 6, the conventional door opening/closing control system opens/closes the door even when an object that is not intended for entry, such as a cat or a box, is detected by the sensor, which causes an unauthorized person to pass through the door, which causes a problem that the door may be used for criminal purposes.

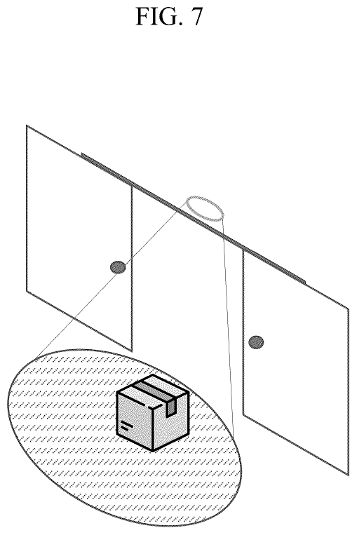

FIGS. 7 to 9 are diagrams illustrating one embodiment of the AI-based self-optimizing door opening/closing system according to the present disclosure. In FIG. 7, the AI-based self-optimizing door opening/closing system 100 may control the door opening/closing operation according to the approach speed of the entry/exit intention object. Here, the AI-based self-optimizing door opening/closing system 100 may determine the opening/closing speed as the door control element and perform the door opening/closing operation according to the movement speed of the entry/exit intention object. Through this, the AI-based self-optimizing door opening/closing system 100 may quickly open/close the door according to the entry/exit intention object, thereby blocking or allowing entry/exit even when the image of the door entry/exit area is not acquired.

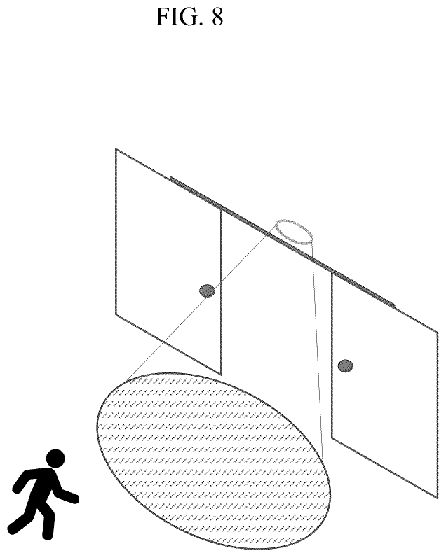

In FIG. 8, the AI-based self-optimizing door opening/closing system 100 may perform the door opening/closing control operation according to the size of the entry/exit intention object. Here, the AI-based self-optimizing door opening/closing system 100 may determine the door opening/closing width as the door control element according to the bounding box of the entry/exit intention object and proceed with the door opening/closing. Here, the AI-based self-optimizing door opening/closing system 100 may control the door to open/close according to the size of the bounding box of the entry/exit intention object when the entry/exit intention object corresponds to a person. The AI-based self-optimizing door opening/closing system 100 is not necessarily limited thereto, and can control the door to open/close wider than the bounding box when the entry/exit intention object corresponds to a person, an object, or multiple persons.

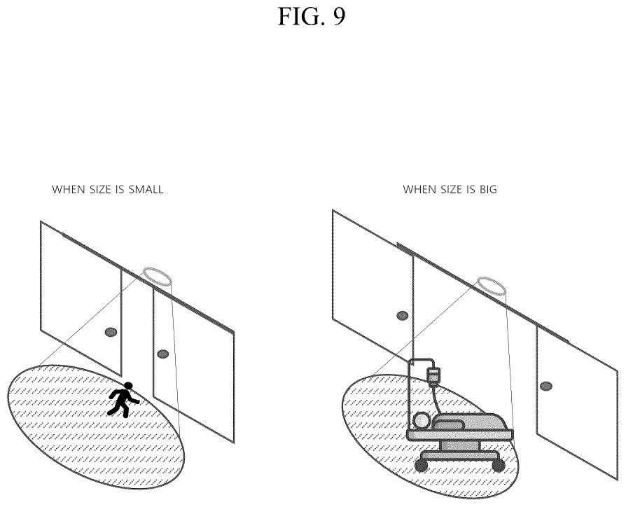

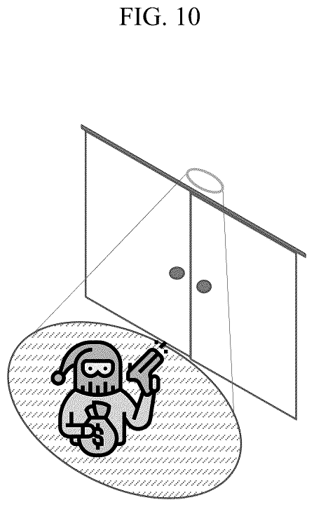

In FIG. 9, the AI-based self-optimizing door opening/closing system 100 may perform a door opening/closing operation according to the risk level of the entry/exit intention object. Here, the AI-based self-optimizing door opening/closing system 100 may analyze the clothing of the entry/exit intention object when the entry/exit intention object corresponds to a person. Here, the AI-based self-optimizing door opening/closing system 100 may analyze the bounding box of the entry/exit intention object and determine the risk level of the entry/exit intention object based on whether the entry/exit intention object contains a knife, a blunt object, or a firearm. The AI-based self-optimizing door opening/closing system 100 is not necessarily limited thereto, and may prevent entry by recognizing the facial area of the entry/exit intention object and restricting the door opening/closing operation when the facial area of the entry/exit intention object is covered by clothing such as a mask, as shown in FIG. 10.

Although the present disclosure has been described above with reference to preferred embodiments thereof, it will be understood by those skilled in the art that various modifications and changes may be made to the present disclosure without departing from the spirit and scope of the present disclosure as set forth in the claims below.

### DETAILED DESCRIPTION OF MAIN ELEMENTS

100: AI-based self-optimizing door opening/closing system
110: image acquisition unit
120: object feature extraction unit
130: door control element determination unit
140: door control influence element determination unit
150: door control feedback unit
160: control unit
210: processor
230: memory
250: user input/output unit
270: network input/output unit
290: communication port section

What is claimed is:

1. An AI-based self-optimizing door opening/closing device comprising:
an image acquisition unit that acquires an image of a door entry area via a camera;
an object feature extraction unit that analyzes the image of the door entry area and extracts features of an entry/exit intention object; and
a door control element determination unit that inputs the features of the entry/exit intention object into an AI-based door control model to optimize a location of the door entry area and determine at least one door control element.

2. The AI-based self-optimizing door opening/closing device of claim 1, wherein the object feature extraction unit extracts the features of the entry/exit intention object from the image of the door entry/exit area through a backbone neural network.

3. The AI-based self-optimizing door opening/closing device of claim 1, wherein the door control element determination unit determines at least one of whether to open or close, an opening/closing width, an opening/closing speed, and an opening/closing time as the at least one door control element through the AI-based door control model and performs door opening/closing.

4. The AI-based self-optimizing door opening/closing device of claim 1, further comprising a door control influence factor determination unit that inputs the features of the entry/exit intention object into an object localizer to determine at least one door control influence factor.

5. The AI-based self-optimizing door opening/closing device of claim 4, wherein the door control influence factor determination unit inputs the features of the entry/exit intention object into a location head to generate a location map, and determines an object validity factor for determining whether to open/close, an object area factor for determining the opening/closing width, an object speed factor for determining the opening/closing speed, and an object distance factor for determining the opening/closing time as the door control influence factors through the location map.

6. The AI-based self-optimizing door opening/closing device of claim 5, wherein the door control influence factor determination unit inputs the features of the entry/exit intention object into a class head to generate a class map, and updates the location map and the class map to maximize a GT similarity between the location map and the class map.

7. The AI-based self-optimizing door opening/closing device of claim 4, further comprising a door control feedback unit that calculates attention for a location map and class map in the object localizer and feedbacks the calculated attention to the door control model.

8. A computer-executable, AI-based, self-optimizing door opening/closing method comprising:
acquiring an image of a door entry area via a camera;
analyzing the image of the door entry area and extracting features of an entry/exit intention object; and
inputting the features of the entry/exit intention object into an AI-based door control model to optimize a location of the door entry area and determine at least one door control element.
